(19) United States
(12) Patent Application Publication
(10) Pub. No.: US 2025/0329825 A1
(43) Pub. Date: Oct. 23, 2025

(54) ELECTROCHEMICAL DEVICE FOR HYBRID ELECTRICAL ENERGY STORAGE AND HYDROGEN PRODUCTION

(71) Applicant: Saudi Arabian Oil Company, Dhahran (SA)

(72) Inventors: Aqil Jamal, Dhahran (SA); Alexey Izgorodin, Dhahran (SA); Abdulrahman S. Alsuhaibani, Dammam (SA); Ahmad O. Khowaiter, Dhahran (SA)

(21) Appl. No.: 18/639,338

(22) Filed: Apr. 18, 2024

(51) Int. Cl. H01M 12/02; H01M 4/13; H01M 50/35; H01M 50/46; H01M 50/627

(52) U.S. Cl. CPC H01M 12/02; H01M 4/13; H01M 50/35; H01M 50/46; H01M 50/627

(57) ABSTRACT

A hybrid electrochemical device configuration that comprises a first electrode that includes a redox reactive material or an alloy based on a transition metal, a second electrode that includes a multi-functional catalyst to catalyze hydrogen evolution reaction, hydrogen oxidation reaction, and water oxidation reaction at the second electrode, a separator disposed between the first and second electrode, an electrolyte disposed between the first electrode and the second electrode, and a conduit which provides the means to compensate for water loss in the electrolyte during electrochemical device operation. At least one valve is included that connects the electrolyte management system to the conduit system and a valve to connect the gas formed in the electrode to the gas management system. The electrochemical device configurations include several individual devices stacked on top of each other and separated from each other using separation plates.

### TECHNICAL FIELD

This disclosure relates to the design and configuration of a hybrid electrochemical device for electrical energy storage and for energy efficient production of high-pressure hydrogen using the same device. A hybrid electrochemical energy storage device is designed based on a redox reactive material or an alloy based on a transition metal, in combination with a multi-functional catalyst to catalyze hydrogen evolution reaction, hydrogen oxidation reaction, and water oxidation reaction.

### BACKGROUND

Energy storage solutions are critical for energy transition demands that require greater contribution from renewable sources. The focus on expanding electrification is accelerating the need for large scale deployment of safe, cost effective, sustainable, and reliable stationary energy storage solutions.

Lithium ion batteries that are widely used have short lifetime, especially in hot climates. The cost for medium- and long-term energy storage for lithium ion batteries is very high, due to low utilization over lifetime. On the other hand, fuel (or chemical) based energy storage systems have lower costs associated with medium- and long-term storage. However, fuels and chemicals have alterative non-energy related applications. The present disclosure addresses these challenges by providing a system with a more robust and improved lifetime, especially in hot climates.

### SUMMARY

An embodiment described herein provides a hybrid electrochemical device which comprises a first electrode that includes a redox reactive material or an alloy based on a transition metal; a second electrode that includes a multi-functional catalyst to catalyze hydrogen evolution reaction, hydrogen oxidation reaction, and water oxidation reaction at the second electrode; a separator disposed between the first and second electrode; an electrolyte disposed between the first electrode and the second electrode; a conduit system that includes the means to replenish water loss in the electrolyte during electrochemical device operation, and an enclosure within which the first electrode, the second electrode, the separator, the electrolyte, and conduit system are disposed; wherein the first electrode and separator includes the means to minimize spatial variation of electrolyte concentration and temperature within the cell. The hybrid electrochemical storage device has at least a valve that is fluidically connected to an electrolyte/water management system and another valve that is fluidically connected to the gas management system.

An aspect described herein provides a hybrid electrochemical storage device in a stacked configuration. The hybrid electrochemical storage device includes several individual electrochemical storage devices that are stacked on top of each other. The individual electrochemical storage device comprises a first electrode that includes a redox reactive material or an alloy based on a transition metal; a second electrode that includes a multi-functional catalyst to catalyze hydrogen evolution reaction, hydrogen oxidation reaction, and water oxidation reaction at the second electrode; a separator disposed between the first and second electrode; an electrolyte disposed between the first electrode and the second electrode; a separation plate disposed between individual electrochemical devices, an enclosure within which each of the individual electrochemical storage device arranged in a stacked configuration are disposed. The stacked configuration of electrochemical storage device includes valves that are fluidically connected to the electrolyte management system and gas management system.

An aspect described herein provides a method for operating a hybrid electrochemical storage device for both electrical energy storage and hydrogen gas production in a fully reversible mode. This includes storing electrical energy by oxidizing a redox reactive material on the first electrode and reducing H₂O to hydrogen on the second electrode; and releasing electrical energy by reducing the redox reactive material on the first electrode and oxidizing hydrogen to H₂O on the second electrode.

The details of one or more implementations are set forth in the accompanying drawings and the description below. Other features and advantages will become apparent from the description, drawings, and the claims.

### BRIEF DESCRIPTION OF DRAWINGS

FIG. 1A is a drawing of the hybrid electrochemical storage device 100.

FIG. 1B is a schematic representation of the layers on electrode 101.

FIG. 1C represents the various implementations on electrode 101.

FIG. 2A is a schematic representation of electrode 102.

FIG. 2B is a schematic representation of layers on electrode 102.

FIG. 3A is a schematic diagram of a separator.

FIG. 3B is a schematic representation of the layers of a separator.

FIG. 4 is a drawing of a common pressure configuration of the electrochemical storage device.

FIG. 5 is a drawing of a differential pressure configuration of the electrochemical storage device.

FIG. 6 is a drawing showing the interconversion between various forms of nickel hydroxide.

FIG. 7 represents a linear configuration of an electrochemical cell stack.

FIG. 8 represents a symmetric configuration of an electrochemical cell stack.

FIG. 9 is a drawing of a common pressure linear configuration stack.

FIG. 10 is a drawing of a differential pressure linear configuration stack.

FIG. 11 is a drawing of a differential pressure symmetric configuration stack.

FIG. 12 is a drawing of a electrolyte management system with two liquid conduits.

FIG. 13 is a drawing of a electrolyte management system that includes two liquid conduits and a gas conduit.

FIG. 14 is a drawing of a electrolyte management system that includes a liquid conduit and a gas conduit.

FIG. 15 is a drawing of a gas management system.

### DETAILED DESCRIPTION

The hybrid electrochemical system addresses the limitations of the lithium ion batteries. It has significantly improved lifetime, especially in hot climates. Additionally, it has drastically low medium- and long-term electrical energy storage costs. The hydrogen production that takes place using the unused renewable energy occurs at a high efficiency and low cost. This hydrogen in turn can be used to facilitate the production of other chemicals and fuels.

The present disclosure provides details of a hybrid electrochemical storage device. In some implementations, the hybrid electrochemical storage device comprises a first electrode that includes a redox reactive material or an alloy based on a transition metal; a second electrode that includes a multi-functional catalyst to catalyze hydrogen evolution reaction, hydrogen oxidation reaction, and water oxidation reaction at the second electrode; a separator disposed between the first and second electrode; an electrolyte disposed between the first electrode and the second electrode; a conduit system that includes means to replenish water loss in the electrolyte during operation; and an enclosure within which the first electrode, the second electrode, the separator, the electrolyte, and the conduit are disposed; wherein the first electrode and/or separator include the means to minimize spatial variation of electrolyte concentration and temperature within the electrochemical storage device. The hybrid electrochemical storage device has at least one valve fluidically connected to the conduit system and one valve fluidically connected to the gas management system. Each valve is fluidically connected to an electrolyte management system and gas management system, respectively.

In some implementations described herein, the hybrid electrochemical storage device includes several individual electrochemical storage devices that are stacked on top of each other and separated from each other using a separation plate. The individual electrochemical storage device comprises a first electrode that includes a redox reactive material or an alloy based on transition metal; a second electrode that includes a multi-functional catalyst to catalyze hydrogen evolution reaction, hydrogen oxidation reaction, and water oxidation reaction at the second electrode; a separator disposed between the first and second electrode; an electrolyte disposed between the first electrode and the second electrode; a conduit system fluidically connected to the electrolyte; separation plate disposed between individual electrochemical devices, and an enclosure within which each of the individual electrochemical storage devices arranged in a stacked configuration are disposed. The stacked configuration of the electrochemical storage device includes at least one valve fluidically connected to the conduit system and one valve fluidically connected to the gas of the second electrode. Each valve may be connected to an electrolyte management system and gas management system, respectively.

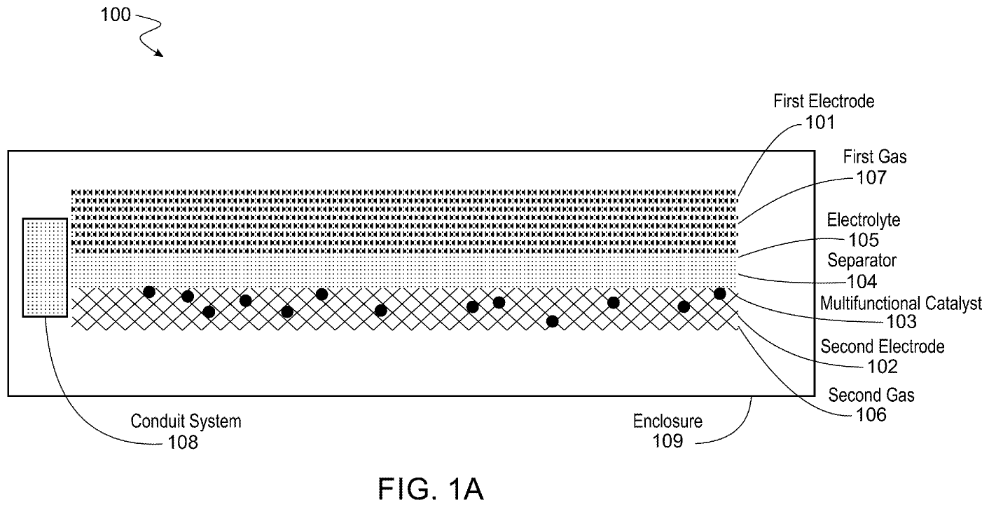

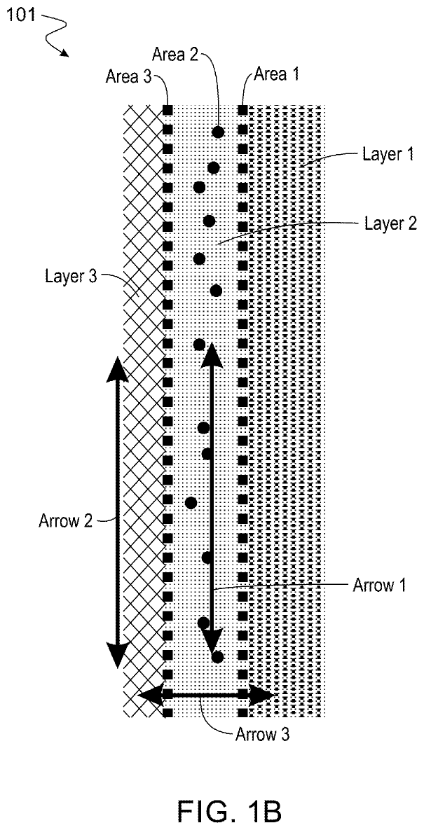

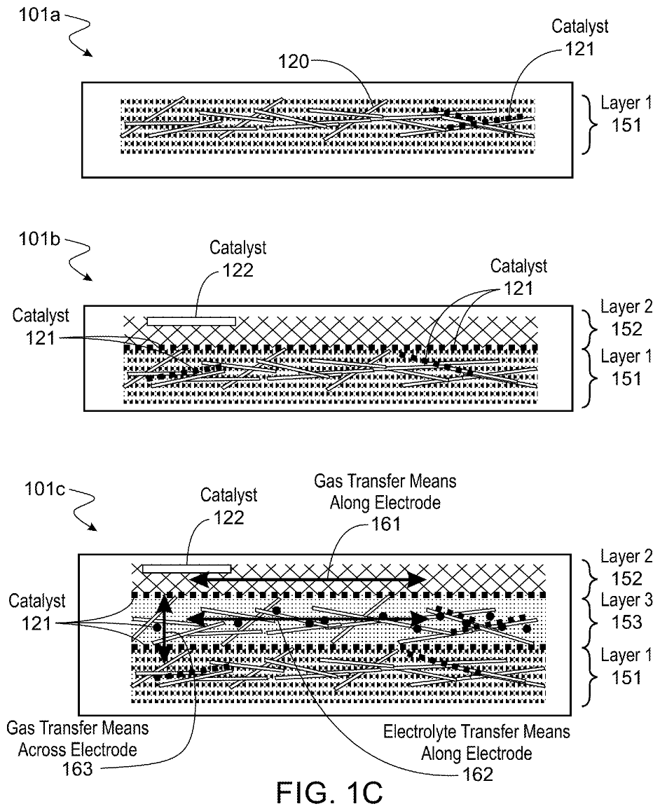

FIG. 1A is a drawing of a hybrid electrochemical storage device 100. The hybrid electrochemical storage device 100 is also referred to herein as a hybrid electrochemical storage cell, electrochemical storage device, electrochemical cell, or cell. The hybrid electrochemical storage device 100 comprises a first electrode 101 including a redox reactive material or an alloy based on transition metal; a second electrode 102 including a multi-functional catalyst 103 to catalyze hydrogen evolution reaction, hydrogen oxidation reaction, and water oxidation reaction at the second electrode; a separator 104 disposed between the first and second electrode; an electrolyte 105 disposed between the first electrode 101 and the second electrode 102; a conduit system 108 and an enclosure 109 within which the first electrode, the second electrode, the separator, the conduit system, and the electrolyte are disposed; wherein the first electrode 101 and/or separator 104 include the means to minimize spatial variation of electrolyte concentration and temperature within the electrochemical cell. The conduit system 108 includes the means to replenish water loss in electrolyte during operation.

Gas 106 may be formed in the electrode 102. Gas 106 may include hydrogen, oxygen, nitrogen and/or air. Gas 107 may be formed in the electrode 101. Gas 107 may include oxygen, nitrogen and/or air. The enclosure 109 includes at least one valve fluidically connected to the conduit system 108 and at least one valve fluidically connected to the gas 106. Each of the valves are fluidically connected to an electrolyte management system and gas management system, respectively. The gas management system conveys gas 106 to and from the electrochemical storage device. In some implementations, electrode 101 has composite, multilayer structure comprising conductive and non-conductive porous materials, structures, and nanostructures that can include deformable elements. Examples include metal and polymer foams, metal alloy foams, metal and polymer meshes, fibrous or porous structures, including composite structures. Individual conductive layers may be electrically connected with each other. Non-conductive porous materials and structures of the electrode 101 can be adjacent or placed in between electrically conductive layers and structures.

In implementations herein, the electrode 101 includes a redox reactive material selected from Ni(OH)₂, NiOOH, or Ni(OH)₂ doped with one or more elements selected from a transition metal group including cobalt, zinc, and or manganese. The cobalt can be cobalt oxide or zinc cobalt oxide. The manganese can be manganese oxide or doped manganese oxide (e.g., doped with nickel, copper, bismuth, cobalt, or other transition or post-transition metals). In some implementations, the electrode 101 includes silver. In some implementations, the material of the electrode 101 includes microstructures or nanostructures to increase contact surface area between the electrode 101 and electrolyte 105 and thus increase power capacity of the device.

FIG. 1B is a schematic representation of the layers on electrode 101. The dots in area 1, area 2, and area 3 represent the preferred locations of water oxidation catalyst. Area 1 is preferred when layer 2 is not included or not conductive. Area 2 is preferred when high surface area is required. Area 3 is preferred to avoid gas bubbles formation within conductive layer 2.

In some implementations, layer 1 is a dense layer with redox reactive material and a small amount of electrolyte. It is conductive and has electrical connection and mechanical support with redox reactive material. It has very slow production of oxygen gas. It facilitates the transfer of oxygen gas to layer 2 and layer 3. In some implementations, layer 2 is optional and has a high porosity layer filled with electrolyte. It can be conductive or not conductive. The main function is to minimize spatial variation of electrolyte concentration and temperature along electrode 101. It facilitates the transfer of oxygen gas to layer 3. It can compressively deform to accommodate any changes in volume of electrode 101 and/or 102.

In some implementations, layer 3 is optional, and it is largely empty of electrolyte. It can be conductive or not conductive. The main function of layer 3 is to provide means for fluidic connection of gas 107 along electrode 101. Layer 3 supports recombination catalyst of hydrogen and oxygen. It can compressively deform to accommodate any changes in volume of electrode 101 and/or 102.

Arrow 1 indicates electrolyte 105 flow along electrode 101. Arrow 2 indicates gas 107 flow along electrode 101. Arrow 3 indicates gas 107 transfer across elements of electrode 101.

FIG. 1C represents the various implementations 101a, 101b, 101c on electrode 101. The redox reactive material of electrode 101 may be coated on a porous conductive substrate 151 (i.e., layer 1) to increase charge storage capacity while maintaining low electrical resistance of the electrode 101. Conductive substrates may include metal foam, such as a nickel foam, or a metal alloy foam. Other exemplary substrates include metal foils, metal meshes, and fibrous conductive substrates. In some implementations, the redox reactive material of the electrode 101 is fully covered with electrolyte 105 to increase contact surface area and thus power of the device.

In some implementations, shown in FIG. 1C, the electrode 101 comprises porous structure 152 (i.e., layer 2) containing gas 107 with the means to fluidically connect and facilitate transfer of the gas 107 along the electrode 101 plane. Porous structure 152 may be largely impermeable to electrolyte 105 even when pressure of electrolyte 105 exceed that of the gas 107 (e.g., 0.1, 0.2, 0.5 bar etc.). This is achieved through the use of appropriate materials or by full or partial coating of the substrate with an appropriate material. Examples of suitable materials include polyethylene, polypropylene, partially or fully fluorinated polymers such as polytetrafluoroethylene (PTFE), fluorinated ethylene propylene (FEP), polyethylenetetrafluoroethylene (ETFE), polyvinylfluoride (PVF), polyvinylidene fluoride (PVDF) and other fluorinated polymers.

In some implementations, the electrode 101 includes at least one structure 153 (layer 3) with the means to uniformly distribute electrolyte 105 along the electrode 101 plane. The structure 153 may include surface modification, additives, and/or interpenetrating networks of hydrophilic materials and polymers, as well as inclusion of chemical compounds to facilitate water transfer. Such modifications may result in the electrode 101 being able to draw water up to a significant height above the electrolyte level (similar to wick) and fully cover the surface of the electrode 101 with the electrolyte 105, even in the case where electrolyte volume is less than the electrolyte permeable volume of the electrode 101. It may be advantageous that structure 153 may not have any/or substantial amount of redox reactive material deposited on the surface in order to facilitate free flow of the electrolyte 105.

In some implementations the structures of electrode 101 (e.g., 151, 153) in contact with electrolyte 105 may include structures 120 to facilitate transport of the gas 107 across electrode 101. In particular, the gas 107 transfer between catalyst 121 and the gas space of the structure 152. Examples include surface modification, inclusion of additives, chemical compounds and/or interpenetrating networks of hydrophobic materials and polymers to facilitate gas transfer.

In some implementations, conductive structures of the electrode 101 include material and/or coating on catalyst 121 to catalyze water oxidation to oxygen continuously. Specific examples include Fe dopped nickel hydroxide, catalysts based on Fe, Ni, Ru, Ir, Co, Fe, W, Cu, Al, Zn, V, Cr, Mn, Ce, Rh including oxides, hydroxides, and oxyhydroxide of individual elements or alloys. It is advantageous that catalyst 121 is fluidically connected with the electrolyte 105 and the structures 120, 152 to transport gas 107. Examples where catalyst 121 can be present include the boundary between structures 120 within structures 151 and/or 152, and electrolyte 105, the interface between structure 151 and structure 153, conductive elements of the structures 151 and/or 153 and interface between structures 153 and 152. In some implementations, catalyst 121 can catalyze oxygen reduction to water.

In some implementations, structure 152 may include catalyst 122 that facilitates recombination between oxygen and hydrogen gas to form water. Catalyst 122 is fluidically connected to the gas 107 and may or may not be fluidically connected to the electrolyte 105 and/or conductive elements of the electrode 101. The electrode 101 may include means of electrolyte transfer 162 and gas transfer 163 as shown in FIG. 1C.

The electrode 101 may include deformable structures 151, 152, 153, and or a separate structure that can be compressively deformed to accommodate potential future changes in volume of the redox reactive material during extended cycling of the electrochemical storage device 100.

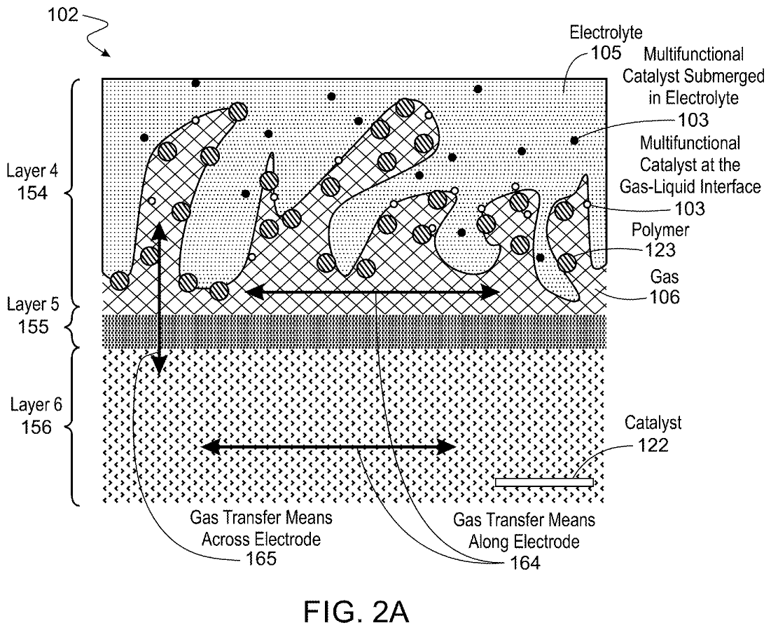

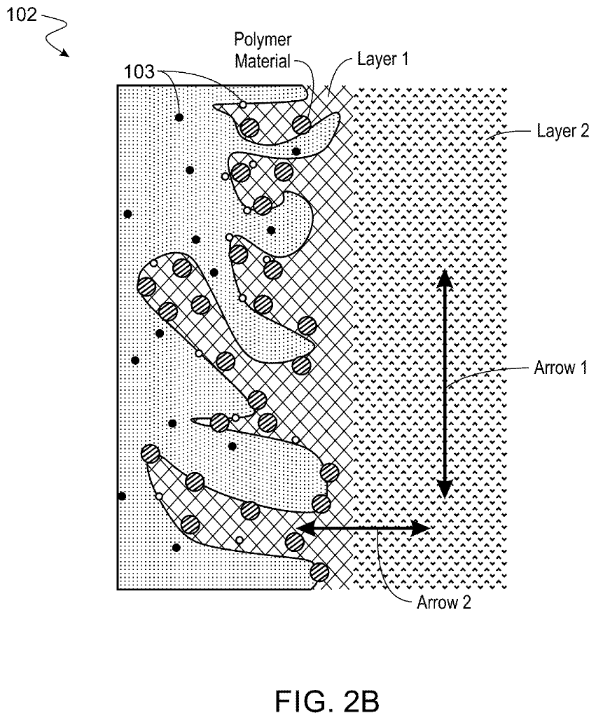

FIG. 2A is a schematic representation of electrode 102. In implementations herein, the second electrode 102 contains at least one gas permeable and electrically conductive structure 154 (layer 4). Structure 154 may include the means 164 and 165 to fluidically connect and facilitate transfer of the gas 106 along the electrode 102 plane. The electrode 102 can have composite structure comprising of multiple layers of metal foams, metal alloy foams, metal meshes, fibrous and porous conductive and non-conductive porous structures and nanostructures, or deformable elements. Individual conductive layers may be electrically connected with each other. The electrode 102 may include layers comprising non-conductive porous materials and structures adjacent to electrically conductive layers. It is advantageous to minimize free volume of the electrode 102. In some implementations, materials for electrode 102 include metal foam, such as nickel foam, copper foam, steel foam, aluminum foam, or others. In some implementations, the material is a metal alloy foam, such as nickel-molybdenum foam, nickel-copper foam, nickel cobalt foam, nickel-tungsten foam, nickel-silver foam, nickel-molybdenum-cobalt foam, or others. Other exemplary materials include metal foils, metal meshes, and fibrous conductive substrates. In other implementations, the conductive substrates are carbon-based materials, such as carbon fibrous paper, carbon cloth, carbon felt, carbon mat, carbon nanotube film, graphite foil, graphite foam, graphite mat, graphene foil, graphene fibers, graphene film, and graphene foam.

In some implementations, multi-functional catalyst 103 is coated on a part or on the entire surface of the conductive elements of the electrode 102. The coating on a porous conductive substrate can increase catalyst utilization and provide low electrical resistance to the electrochemical storage device. In some implementations, some of the conductive elements of the electrode 102 can have a similar chemical composition as a multifunctional catalyst 103 and may not require a coating step. It may be advantageous to increase surface area to volume ratio of the electrode 102 and multi-functional catalyst 103 by any number of roughening techniques known in the art. The multi-functional catalyst 103 is disposed between the electrolyte 105 and electrode 102 and functions to catalyze hydrogen evolution reaction, hydrogen oxidation reaction, and water oxidation reaction at the electrode 102. Hydrogen oxidation may occur at the 3-phase interface between the multi-functional catalyst 103, electrolyte 105, and gas 106. In some implementations where a 3-phase interface is not available, hydrogen gas may diffuse through the thin layer of the electrolyte 105 covering the multi-functional catalyst 103 to the surface of the catalyst.

The electrode 102 includes various means to facilitate hydrogen transfer from the space occupied by gas 106 to the contact area between the multi-catalyst 103 and the electrolyte 105. These include surface modification of electrode 102 and multi-functional catalyst 103, inclusion of additives, and/or interpenetrating networks that include suitable materials and polymers, as well as chemical inclusion in the structure of compounds that facilitate hydrogen diffusion.

In some implementations, multi-functional catalyst 103 includes nickel-molybdenum, nickel-tungsten, nickel-tungsten-cobalt, nickel-carbon based composites, nickel-molybdenum-cobalt alloy. The multi-functional catalyst may also include precious metals and their alloys such as platinum, palladium, iridium, gold, rhodium, silver, and their alloys with precious and non-precious transition metals such as platinum, palladium, iridium, gold, rhodium, silver, nickel, cobalt, manganese, iron, molybdenum, and tungsten, as well as a mixture of different materials, which contribute to water oxidation, hydrogen evolution, and oxidation reaction as a whole. The material of the multi-functional catalyst 103 and in some implementations electrode 102 are micro structured or nanostructured, to increase contact surface area with electrolyte 105 and thus increase power capacity of the device. In some implementations, multi-functional catalyst 103 includes material to catalyze oxygen reduction to water. In some implementations the structure 154 including a multi-functional catalyst 103 may be partially coated with a polymer 123 to maximize 3-phase interface between catalyst 103, electrolyte 105, and gas 106. This is achieved by facilitating maximum contact surface area between catalyst 103 and electrolyte 105 while minimizing diffusion length through electrolyte 105 between gas 106 and catalyst 103. In other implementations, some of the electrode 102 may be fully or partially coated with a polymer material to enable gas 106 to be fluidically connected along electrode 102 even when pressure of electrolyte 105 exceeds the pressure of gas 106. Examples of polymer material includes polyethylene, polypropylene, partially or fully fluorinated polymers such as polytetrafluoroethylene (PTFE), fluorinated ethylene propylene (FEP), polyethylenetetrafluoroethylene (ETFE), polyvinylfluoride (PVF), polyvinylidene fluoride (PVDF) and other fluorinated polymers.

In some implementations, the electrode 102 comprises porous structures 155 and/or 156 that individually or in combination are largely impermeable to electrolyte 105 even when pressure of the electrolyte 105 exceed that of the gas 106 (e.g., 0.1, 0.2, 0.5 bar etc.). This is achieved through the use of appropriate materials or by full or partial coating of the substrate with an appropriate material. Examples of suitable materials include polyethylene, polypropylene, partially or fully fluorinated polymers such as polytetrafluoroethylene (PTFE), fluorinated ethylene propylene (FEP), polyethylenetetrafluoroethylene (ETFE), polyvinylfluoride (PVF), polyvinylidene fluoride (PVDF) and other fluorinated polymers.

In some implementations, the electrode 102 comprises porous structure 156 (i.e., layer 6) containing gas 106 with the means 164 to fluidically connect and facilitate transfer of the gas 106 along the electrode 102 plane.

In some implementations the structures of electrode 102 (e.g., 154, 155, 156) may include means 165 to facilitate transport of the gas 106 across the electrode 102. In particular, the gas 106 transfer between multi-functional catalyst 103 and the gas space of the structure 156. Examples include surface modification, inclusion of additives, chemical compounds and/or interpenetrating networks of hydrophobic materials and polymers to facilitate gas transfer.

In some cases, structure 156 may include catalyst 122 that facilitates recombination between oxygen and hydrogen gas to form water. Catalyst 122 is fluidically connected to the gas 106 and may or may not be connected to the conductive elements of the electrode 102.

The electrode 102 may include deformable structures 154, 155, 156, and/or a separate structure that can be compressively deformed to accommodate potential future changes in volume of the redox reactive material during extended cycling of the electrochemical storage device 100.

FIG. 2B shows the layers on electrode 102. Layer 1 is the conductive later that contains multifunctional catalyst and the electrolyte. This layer forms an electrical connection with the multi-functional catalyst and gives mechanical support to it. It also facilitates the transfer of gas 106 to layer 2. Layer 2 is an optional porous layer largely empty of electrolyte. It can be conductive or not conductive. It provides the means for fluidic connection of gas 106 along electrode 102. It also supports the recombination of hydrogen and oxygen. It compressively deforms to accommodate any changes in the volume of electrode 101 and/or 102. Arrow 1 indicates the gas 106 flow along electrode 102. Arrow 2 indicates gas 106 transfer across elements of electrode 102. The multi-functional catalyst 103 are located at the 3-phase interface between electrolyte 105, multifunctional catalyst 103, and gas 106 or at the interface between multifunctional catalyst 103 and electrolyte 105, where gas 106 is required to diffuse through the electrolyte 105.

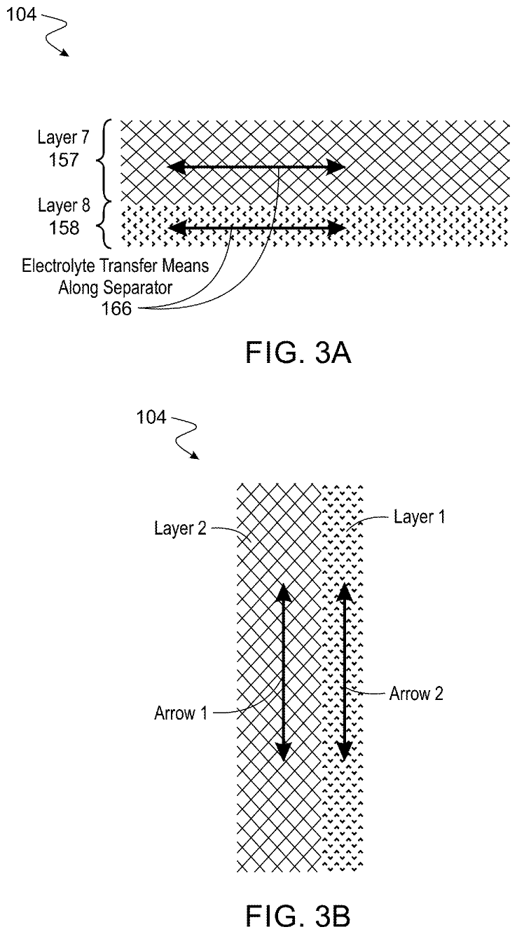

FIG. 3A is a schematic diagram of a separator. Separator 104 may be inserted as a spacer between the first electrode 101 and second electrode 102. The separator is non-oxidizing, resistant to chemicals, provides water transport, and has good ion conductivity. In some implementations, separator 104 may have composite structure comprising of multiple layers of foams, meshes, fibrous and conductive and non-conductive porous structures and nanostructures. Separator 104 may include layers comprising non-conductive porous materials and structures adjacent to electrically conductive layers. Separator 104 includes at least one structure 157 (layer 7) to electrically isolate the first electrode 101 and the second electrode 102 while preventing transport of the gas between the gas 107 of the electrode 101 and the gas 106 of the electrode 102. In some implementations, separator 104 includes the structure 158 (layer 8). Structures 157 and 158 may include means 166 to facilitate free flow of the electrolyte 105 along the separator 104 plane and means to minimize spatial variation of electrolyte concentration and temperature.

In some implementations, separator 104 may contain a portion of the electrolyte 105. In addition to electrically separating the first electrode 101 from the second electrode 102, separator 104 may provide a reservoir of electrolyte 105 that buffers the electrodes from either drying out or flooding. In some cases, the separator 104 facilitates differential pressure operation between electrolyte 105 in the first electrode 101 and gas 106 in the second electrode 102, by preventing electrolyte flow into second electrode 102 and/or gas 106 flow into separator 104 or the first electrode 101. In some cases, structure 157 of the separator 104 may be an ion conducting membrane, porous or a micro-porous thin plate, cloth, bar, frame. In some implementations, separator 104 may function to retain the electrolyte 105 and does not obstruct the ionic conduction and/or flow of the electrolyte 105.

The separator 104 may include deformable element disposed between electrodes 101 and 102, that can be compressively deformed to accommodate potential future changes in volume of electrodes 101 and 102 during extended cycling of the electrochemical storage device 100. In some implementations, the expansion of electrode 101 compresses the separator 104 and forces out electrolyte 105 from the separator 104. In this case, the separator 104 becomes denser and less conductive leading to a decrease in overall efficiency of the electrochemical storage device 100 and eventual failure. In some implementations, the deformable element disposed between electrodes 101 and 102 allows the use of separator 104 with higher initial porosity and compensates for a potential future loss of the electrolyte 105.

FIG. 3B is a schematic representation of the layers of a separator. Layer 1 is a non-conductive porous layer that contains electrolyte. It is ideally very thin to maintain low electrolyte resistance between electrode 101 and electrode 102. It prevents gas transfer between electrode 101 and 102. Optionally it can minimize spatial variation of electrolyte concentration and temperature along electrode 101.

In some implementations, the thickness of the separator 104 is less than the distance between the electrode 101 and the electrode 102 in the cell 100 during operation. Layer 2 is optional and it is a highly porous layer that contains electrolyte. It can be conductive or not. It can in some instances minimize spatial variation of electrolyte concentration and temperature along separator 104. It can optionally compressively deform to accommodate any changes in volume of electrode 101 and/or 102. The arrows 1 and 2 indicate the electrolyte 105 flow along separator 104.

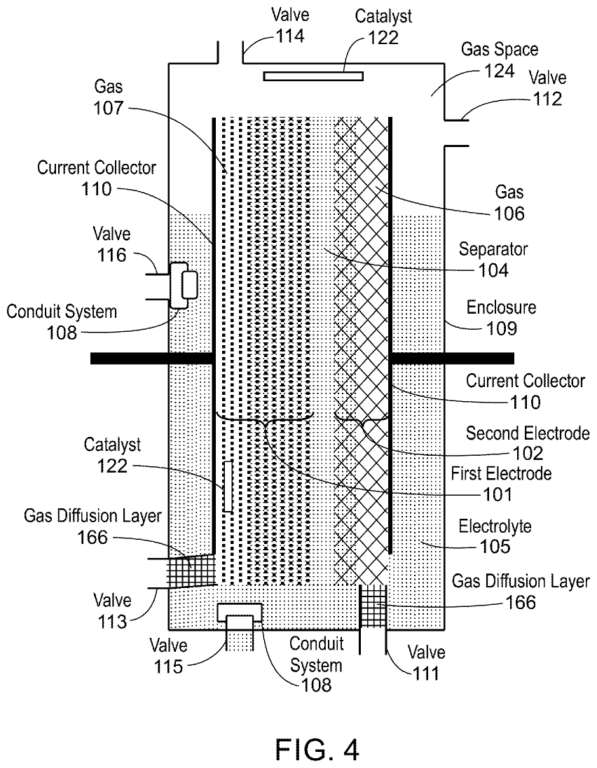

FIG. 4 is a drawing of a common pressure configuration of the electrochemical storage device 100. The electrochemical storage device 100 includes a first electrode 101, a second electrode 102, a separator 104, and electrolyte 105, all disposed in an enclosure 109. The enclosure 109 can include a valve 115 and a valve 116 which are fluidically connected to an electrolyte 105 through conduit systems 108. In addition, in some implementations, the enclosure includes a valve 111 and valve 112, which are fluidically connected to the gas 106 that is contained in the electrode 102 and an inlet 113 and outlet 114, which are fluidically connected to the gas 107 that is contained in the electrode 101. Electrolyte 105, gas 106, and gas 107 are fluidically connected within the common enclosure 109 through gas space 124. This configuration maintains a common pressure between electrolyte 105, gas 106, and gas 107 during system operation. In some implementations, electrolyte 105, gas 106, and gas 107 present in the system occupy various parts of the enclosure 109, at the same time electrolyte 105 is largely prevented from flowing into the gas 106 of electrode 102 and gas 107 of the electrode 101, valves 111, 112, 113, and 114 through surface modification, inclusion of additives and/or interpenetrating networks of hydrophobic materials and polymers, as well as inclusion of chemical compounds in the structure.

Gas diffusion layers 166 may be used to provide fluid connection between the gas space of electrode 102, valves 111, and 112 as well as between gas space of electrode 101, valves 113, and 114. The gas diffusion layer 166 may be selected from materials and structures largely permeable to gas (e.g., hydrogen and oxygen) but are impermeable to electrolyte 105. Current collectors 110 in contact with the electrodes 101 and 102 enable withdrawal of electrical current from the electrochemical device while allowing to maintain differential pressure between gasses and liquids across enclosure 109. In some embodiments, one or both current collectors 110 are not electrically connected with the enclosure 109. Valves 115 and 116 are fluidly connected with electrolyte 105 through conduit system 108 and can be used to withdraw or supply electrolyte and or water mixture to the cell 100. In some embodiments, a single bidirectional valve can replace valves 115 and 116. In some embodiments, a single bidirectional valve is fluidly connected to gas space 124 and gas management system. A single bidirectional valve can replace valves 111, 112, 113, and 114.

Common pressure configuration may include catalyst 122 fluidically connected to gas space 124 to catalyze reaction between hydrogen and oxygen to form water. The catalyst 122 in some cases may have electrical connection with an enclosure 109.

The common pressure configuration of electrochemical cell 100 contains at least one conduit system 108 fluidically connected to the electrolyte 105 and an electrolyte management system. Conduit system 108 comprise the means to replenish water loss in the electrolyte 105 during operation of the cell 100. The water loss in electrolyte 105 may be caused by water oxidation/reduction reactions as well as process of water evaporation into the gas 106 of the electrode 102 and the gas 107 of the electrode 101.

In some implementations, pure water can be supplied to the cell 100 from an electrolyte management system through the single conduit system 108 to compensate for the water loss in the electrolyte 105. Some examples include maintaining constant pressure of water through conduit system 108 between electrolyte 105 and electrolyte management system or supplying water intermittently though conduit system 108 using a system of valves or check-valves that can in some instances be operated by gravity forces, springs, and/or pressure variations between elements of the cell 100 (i.e., electrolyte 105, gas 106, gas 107) and electrolyte management system or due to negative pressure caused by reduction of electrolyte 105 volume in the cell 100 upon water loss. This arrangement provides very low conductivity across conduit system 108 between electrolyte 105 of the cell 100 and electrolyte management system.

In other implementations, electrolyte 105 with higher water content can be supplied from electrolyte management system through the first conduit system 108 into the cell 100, while the electrolyte 105 with lower water content can be discharged from the cell 100 into electrolyte management system through the first or the second conduit system 108. Water can be added to the discharged low water content electrolyte forming high water content electrolyte and supplied to the first conduit system 108, thus replenishing water loss in the cell 100. It is possible to utilize a single conduit system with features to both supply and withdraw electrolyte 105 from cell 100 within a single device. It may be advantageous, however, to use two spatially separated conduit systems to supply and discharge the electrolyte 105 from cell 100. This can promote electrolyte 105 circulation throughout the elements of the cell 100 and reduce spatial variation in electrolyte concentration within the cell 100.

In some implementations it may be beneficial to substantially reduce conductivity across conduit system 108 between electrolyte 105 of the cell 100 and electrolyte management system. Thus, the conduit system 108 can comprise the means to increase flow path of the fluid, or the means to terminate the flow of the fluid at a particular time. Examples include formation of long flow channels with low cross-sectional area to increase fluid resistance or maintaining intermittent fluidical connection between electrolyte 105 and electrolyte management system using system of valves or various types of check-valves known in the art that can in some instances be operated by gravity forces, springs, and/or pressure variations between elements of the cell 100 (i.e., electrolyte 105, gas 106, gas 107) and electrolyte management system.

Spatial variations in electrolyte concentration along the cell 100 may increase the internal resistance of the cell 100 and reduce overall energy efficiency during operation. This negative effect can be further augmented by variations in temperature within the cell 100 that results in the high temperature areas to lose more water compared to the low temperature areas. The first electrode 101 and/or separator 104 contain means to minimize spatial variation in concentration of the electrolyte 105 and temperature within the cell 100. Examples include liquid conduits (e.g., pores, fillers) that can allow circulation of the electrolyte 105 along the plane of the cell 100.

Electrolyte flow can be enabled through variation in the electrolyte density between various parts of the cell 100 due to concentration and/or temperature gradients. It may be beneficial to position conduit system 108 in a configuration that supplies water or electrolyte with high water content into the cell 100 at the lower portion of electrolyte 105 within the cell 100. Electrolyte with higher water content has lower density compared to the electrolyte with lower water content, thus promoting the flow of electrolyte 105 through the cell 100 and consequently reducing spatial variation of the electrolyte 105 concentration within the cell 100. In another example, electrolyte flow can be induced by gases generated in the cell 100 through buoyancy or due to variation in the volume of the gas 106 and the gas 107 within the cell 100. Another example is based on changes in differential pressure between the electrolyte 105 and the fluid of the electrolyte management system during operation (e.g., rise and fall in gas pressure within the cell 100) in conjunction with a system of valves and/or check-valves. Other examples include the use of external pumps or mechanical systems that allow change of electrolyte management system fluid pressure.

Electrolyte 105 is the medium through which ions are conducted during the electro-chemical reaction inside the electrochemical storage device 100. Electrolyte 105 in different parts of the device may have variation in water content. In some implementations, the electrolyte includes 26 wt % KOH in water. In some implementations, the electrolyte is a potassium and/or sodium hydroxide water solution. Gas 106 may include hydrogen, oxygen, nitrogen, and/or air. Gas 107 may include oxygen, nitrogen, and/or air.

In some embodiments, electrolyte 105 may include additives that can substantially change surface tension, viscosity of the electrolyte, and/or water vapor pressure over the electrolyte 105.

In some embodiments, electrolyte 105 can include components used as mediators of electrochemical reactions.

Enclosure 109 may have several configurations. The first electrode 101, the second electrode 102, multi-functional catalyst 103, the separator 104, the electrolyte 105, the gas 106, the gas 107, and the conduit system 108 are disposed within enclosure 109. The enclosure 109 may include at least one valve fluidly connected to the gas 106 and gas management system and at least one valve fluidly connected to the conduit system 108 and electrolyte management system. In case where two valves are fluidly connected to the gas 106, one valve can be used as an inlet valve and another as an outlet valve. Similarly, when two valves are fluidically connected to the one or several conduit systems 108, one valve can be an inlet valve and another an outlet valve. In some implementations, additional one or two valves can be fluidically connected to the gas 107 and gas management system. When two valves are used one can be an inlet valve and another can be an outlet valve.

In some implementations, various internal parts of the enclosure 109 come into contact with the gas 106 and the gas 107 (e.g., hydrogen and oxygen gases). It may be advantageous to include catalyst 122 that promote recombination of hydrogen and oxygen to form water.

In some implementations, the enclosure 109 may include one electrical connector that allows to connect the first electrode 101 or the second electrode 102 with external power supply without being electrically connected to the enclosure 109. In this case, the remaining first electrode 101 or the second electrode 102 can be electrically connected to the power supply through the enclosure 109.

In some implementations, the enclosure 109 may include at least two electrical connectors that allow to electrically connect the first electrode 101 and the second electrode 102 with external power supply and are not in electrically connected to the enclosure 109. The electrical connectors allow to maintain differential pressure between inner and outer parts of the enclosure 109.

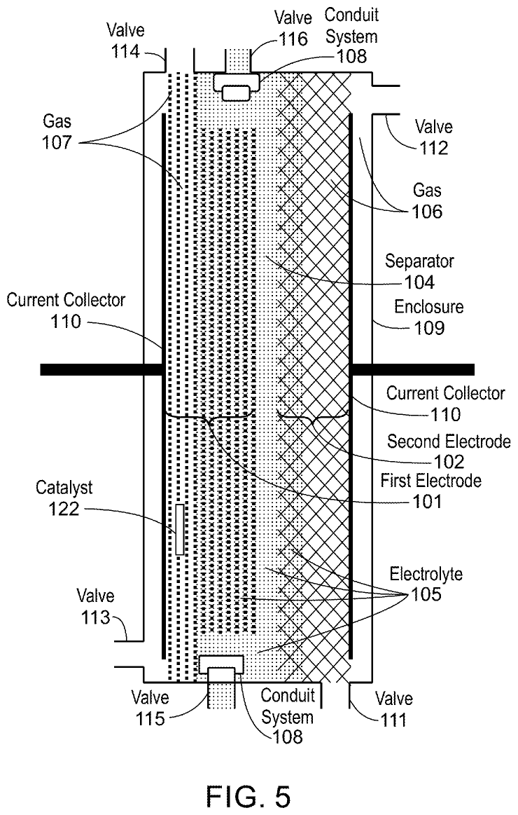

FIG. 5 is a drawing of a differential pressure configuration of the electrochemical storage device 100 disposed in enclosure 109. The gas 107 of the electrode 101 and the gas 106 of the electrode 102 are disposed within separate compartments of the enclosure and fluidically separated by the electrolyte 105. The electrolyte 105 is in fluidic contact with the gas 107 and the gas 106 through the electrode 101 and the electrode 102, respectively. In some implementations, electrolyte 105 is fluidically connected to the valves 115 and 116 through conduit systems 108, the gas 106 is fluidically connected to the valves 111 and 112 and the gas 107 is fluidically connected to the valves 113 and 114. This configuration facilitates maintaining differential pressure between electrolyte 105, gas 106, and gas 107 across the electrode 102 and 101. The elements of the electrode 101 and the electrode 102 may be connected among each other of with the enclosure 109 by means of any scaling techniques known in the art so that electrolyte 105 is prevented from being fluidly connected with valves 111, 112, 113, and 114.

Current collectors 110 in contact with electrodes 101 and 102 enable withdrawal of electrical current from the electrochemical device while allowing to maintain differential pressure between gasses and liquids across enclosure 109. In some embodiments, one or both current collectors 110 are not electrically connected with the enclosure 109.

Valves 115 and 116 are fluidly connected with electrolyte 105 through conduit system 108 and can be used to withdraw or supply electrolyte and or water mixture to the cell 100. In some embodiments, a single bidirectional valve can replace valves 115 and 116.

In some embodiments, a single bidirectional valve fluidly connected to the gas 106 and gas management system can replace valves 111 and 112. In some embodiments, a single bidirectional valve fluidly connected to gas 107 and gas management system can replace valves 113 and 114.

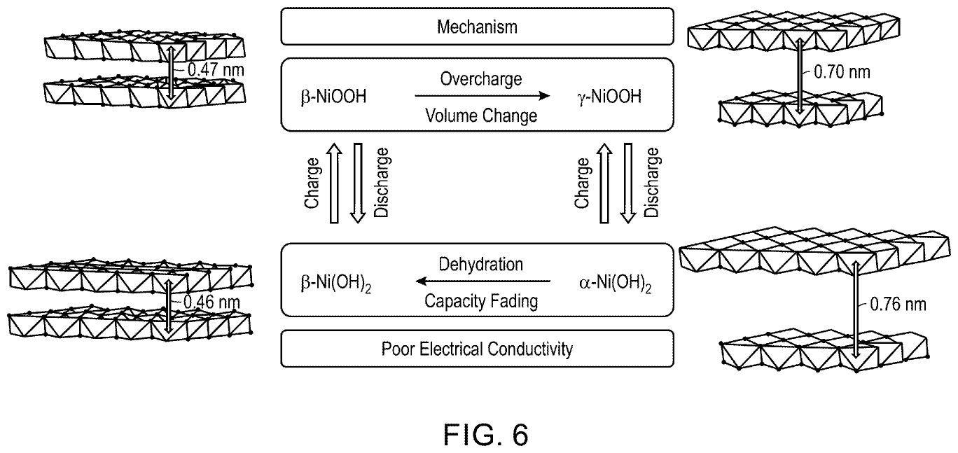

FIG. 6 is a drawing showing the interconversion between various forms of nickel hydroxide. In implementations described herein, nickel hydroxide (Ni(OH)₂) is used as a redox reactive material for electrode 101 and β-NiOOH is the oxidized form (charged form) that has an interspace distance of 0.47 nm. The phase transition from reduced form β-Ni(OH)₂ to oxidized form β-NiOOH occurs with a slight structural change, which ensures excellent reversibility. Phase transition between alternative reduced form of nickel hydroxide α-Ni(OH)₂ and alternative oxidized form of nickel hydroxide γ-NiOOH requires relatively larger change in the interspace distance (from 0.76 to 0.70 nm) and re-orientation of the NiO₂ sheets. Alkaline cations in the electrolyte 105, e.g., Na⁺ or K⁺, are intercalated into the γ-NiOOH layers together with water to compensate for the change in charge during deprotonation.

Typically, overcharge of nickel hydroxide leads to a large volume expansion of the redox reactive material and thus should be carefully prevented to ensure the structural stability of the electrode 101. Addition of cobalt oxide to the redox reactive material (e.g., β-Ni(OH)₂) may improve the high-rate capacity of the electrode 101. Presence of cobalt (Co) may lead to a uniform cobalt hydroxide (Co(OH)₂) coating layer formed on the surface of the β-Ni(OH)₂ particle, which may be subsequently oxidized to CoOOH during charging. The formed CoOOH provides a good electrical path between the Ni(OH)₂ particles and the electrode 101. During discharge, CoOOH is not reduced back to Co(OH)₂ at the working potential of Ni(OH)₂. Moreover, CoOOH may prevent the formation of γ-NiOOH by improving the electrical connection over the electrode particle.

During electrical energy storage cycle a positive potential is applied to the electrode 101 and a negative potential is applied to the electrode 102. In some embodiments, during this cycle water accepts electrons and is reduced forming hydrogen gas and hydroxide ions at the interface between the multi-functional catalyst 103 and electrolyte 105 and/or separator 104. Separator 104 allows the transfer of ions and water between the surface of multi-functional catalyst 103 and redox reactive material of the electrode 101, while electrically isolating electrodes 101 and 102. Redox reactive material of the electrode 101 in contact with electrolyte 105 release electrons and is oxidized. In implementations where nickel hydroxide is used as redox reactive material, nickel hydroxide (i.e., Ni(OH)₂) release electrons and is oxidized to nickel oxyhydroxide (i.e., NiOOH).

During electrical energy storage cycle hydrogen gas is generated at a rate proportionate to the current passed through the cell (FIGS. 4 and 5). Generated hydrogen gas increases pressure of the gas 106 and can be withdrawn from the cell 100 through valves 111 and 112. In some embodiments, the gas 106 can be withdrawn from the cell 100 at elevated pressure (e.g., more than 1 bar, 5 bar, 10 bar, 15 bar, 20 bar, 25 bar, 30 bar).

The electrochemical storage device 100 generates electrical energy during the electrical energy release cycle. During this cycle hydrogen gas is added through valves 111 and/or 112 to the gas 106. Electrons are release upon hydrogen oxidation to water at the interface between multi-functional catalyst 103, electrolyte 105 and or separator 104. The electrolyte 105 and/or separator 104 allows ions and water transfer between multi-functional catalyst 103 and redox-reactive material of electrode 101. Redox reactive material in electrode 101 in contact with electrolyte 105 accepts electrons and is reduced. In cases where nickel hydroxide is used as the redox reactive material, nickel oxyhydroxide (e.g., NiOOH) accepts electrons and is reduced to nickel hydroxide (e.g., Ni(OH)₂).

During electrical energy release cycle, hydrogen gas is consumed at a rate proportionate to the current passed through the cell. Thus, pressure of the gas 106 may decrease. Hydrogen gas may be supplied to the electrochemical storage device 100 through valves 111 and/or 112 to maintain partial pressure in the gas 106 of at least 1 bar, 2 bar, 5 bar, 10 bar, etc. In some implementations the partial pressure of hydrogen in the gas 106 may be less than 1 bar. A portion of gas other than hydrogen can be supplied to the cell 100 through valves 111 and/or 112 to maintain pressure of the gas 106 at or above 1 bar. This may simplify the structure of the device and in some cases avoid flooding of the electrode 102 with electrolyte 105 as well as avoid volatilization of electrolyte 105 components (e.g., water). Examples of suitable gases include oxygen, nitrogen, and/or air.

It may also be advantageous to utilize hydrogen gas generated during electrical energy storage cycle in alternative applications or to utilize externally procured hydrogen gas during electrical energy release cycle of the cell 100. Thus, the amount of charge stored in the redox reactive material of the cell 100 may not be equal to the amount of charge stored in the available hydrogen gas. The amount of charge stored in redox reactive material can be reduced compared to the amount of hydrogen available (i.e., cell balancing process) via oxidation of water on the electrode 101 during electrical energy storage cycle (i.e., cell balancing type 1); concurrent reduction of redox reactive material and proportionate oxidation of water on the electrode 101 (i.e., cell balancing type 2); concurrent reduction of redox reactive material and proportionate oxidation of water on the electrode 102 (i.e., cell balancing type 3). The amount of charge stored in the redox reactive material can be increased compared to the amount of hydrogen available (i.e., cell unbalancing process) via concurrent oxidation of redox reactive material and reduction of oxygen to water on the electrode 102.

In some implementations, during electrical energy storage cycle in addition to reduction of redox reactive material on the electrode 101, water can be concurrently reduced to oxygen on the elements of the electrode 101 and/or catalyst 121 (cell balancing process type 1). The amount of charge utilized towards reduction of water to oxygen for a particular configuration can be controlled through the choice of material for catalyst 121, potential applied to the electrode 101 and oxygen pressure in the electrode 101, among others.

In some implementations, the elements of the electrode 101 may promote continuous oxidation of water to oxygen with concurrent proportionate reduction of redox reactive material (cell balancing process type 2). The amount of charge utilized towards reduction of water to oxygen for a particular configuration can be controlled through the choice of material for catalyst 121, oxygen pressure in the electrode 101, among others. In some implementations, cell balancing process type 2 can be maintained at all times given sufficient charge stored in the redox reactive material.

Generated oxygen gas from cell balancing process type 1 and type 2 increases pressure of the gas 107 and can be released from the cell 100 through valves 113 and 114 at atmospheric or elevated pressures. In addition, sweeping gas can be circulated using valves 113 and 114 to reduce partial pressure of oxygen in the gas 107. In some implementations, the pressure of the gas 107 is maintained substantially equal to the pressure of the gas 106.

In some implementations, there may be nearly complete oxidation of the available hydrogen gas in the gas 106, while a portion of the redox reactive material of the electrode 101 remains oxidized. Cell balancing process type 3 can occur upon applying a small resistive load (e.g., short circuit) between electrodes 101 and 102 or upon applying a small negative potential to the electrode 101 and a small positive potential to the electrode 102.

During this process, water releases electrons and is oxidized to oxygen on the surface of the multi-functional catalyst 103 in contact with electrolyte 105 and/or separator 104, while redox reactive material of electrode 101 in contact with electrolyte 105 accepts electrons and is reduced. The electrolyte 105 and/or separator 104 allows ions and water transfer between multi-functional catalyst and redox reactive material of electrode 101. In implementations where nickel hydroxide is used as a redox reactive material, nickel oxyhydroxide (e.g., NiOOH) accepts electrons and is reduced to nickel hydroxide (e.g., Ni(OH)₂). This process may continue until most of the redox reactive material of the electrode 101 is fully reduced or until electrodes 101 and 102 are disconnected.

The rate of the reaction can be controlled through variation of the resistive load, or applied potential between electrodes 101 and 102. Applied potential can be less than 0.05 V, 0.1 V, 0.2 V, 0.5 V, etc. It may be advantageous that applied potentials between the electrode 101 and electrode 102 are sufficiently low so as to prevent over discharge of the redox reactive material of the electrode 101.

Cell balancing process type 3 may prevent and/or reverse build-up of undesirable redox components in the redox reactive material of the first electrode 101. Examples include formation α-Ni(OH)₂ and γ-NiOOH in nickel hydroxide redox reactive material during charge and discharge cycles.

Cell balancing process type 3 can be conducted during periods when electrochemical storage device 100 is not used for electrical energy storage or release cycles (i.e., during stand-by periods). In cases where renewable energy is used to power electrochemical storage device 100, substantial stand-by periods may be available.

In some embodiments, the cell unbalancing process occurs when a positive potential is applied to the electrode 101 and a negative potential is applied to the electrode 102 so that oxygen present in the gas 106 is reduced to water on the catalyst 103 while redox reactive material of the electrode 101 is concurrently oxidized. Muti-functional catalyst 103 may include the means to catalyze oxygen reduction to water. Furthermore, an oxygen containing gas 106 can be supplied to the cell 100 using valves 111 and/or 112. The rate of the reaction can be controlled through variation of the applied potential between electrodes 101 and 102, oxygen pressure in the electrode 102, and material of the multi-functional catalyst 103, among others. Applied potential can be less than 0.05 V, 0.1 V, 0.2 V, 0.5 V, etc.

Multiple cells 100 can be electrically connected in parallel (i.e., first electrodes 101 of multiple individual cells 100 are electrically connected and second electrodes 102 of multiple individual cells 100 are electrically connected), in series (i.e., first electrodes 101 of cell 100 is electrically connected with a second electrode 102 of another cell 100) and as a combination of both (i.e., several cells 100 connected in parallel form sets, multiple sets can be electrically connected in series).

Electrical connection of multiple electrochemical storage devices 100 in series or as a combination of connection in parallel and in series allows to supply power to multiple cells 100 at higher voltages compared to the voltage applied to an individual cell 100. Thus, for a given power it allows to reduce electrical current, resistive losses and subsequently improve overall energy efficiency.

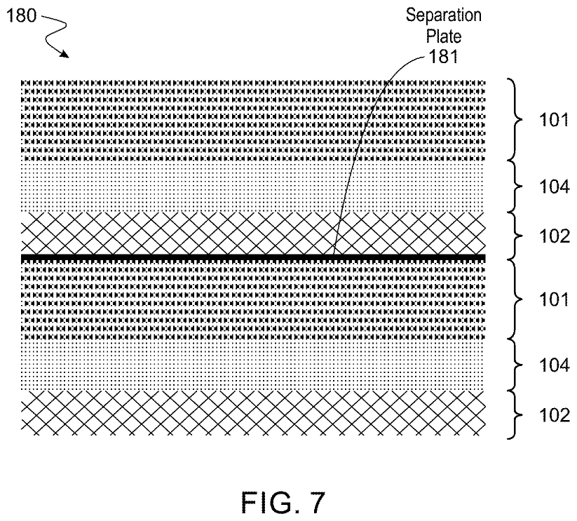

FIG. 7 represents a linear configuration stack of electrochemical cell. In some embodiments, two or more cells 100 adjacent to each other can form a linear configuration stack 180 where electrode 101 of the first cell 100 is facing towards electrode 102 of the adjacent cell 100 and so on. Each cell 100 has a separator 104 disposed between the electrodes 101 and 102. A separation plate 181 is disposed between each cell 100. It is advantageous that multiple cells 100 of the linear configuration stack 180 are electrically connected in series while it is also possible to electrically connect them in parallel. In some embodiments, a set can include multiple cells 100 in a linear configuration stack with cells electrically connected in parallel. Several such sets can be adjacent to each other electrically connected in series.

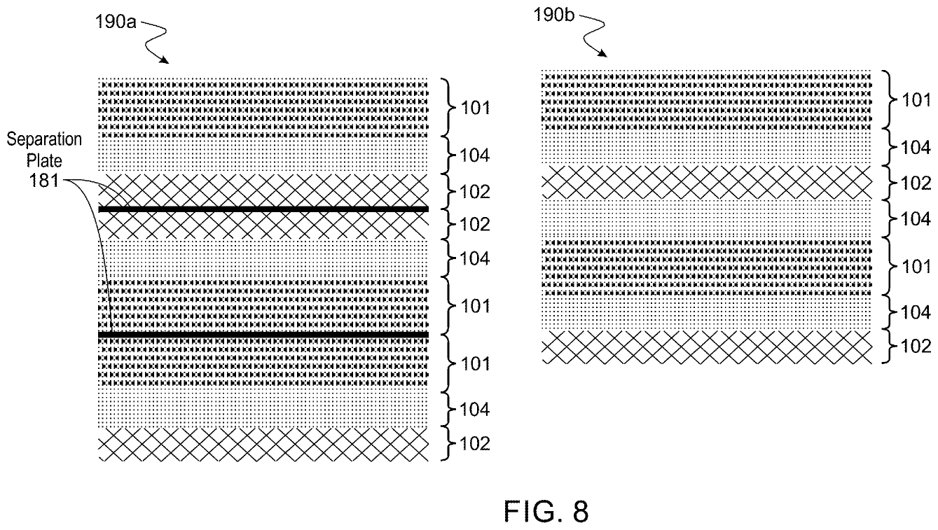

FIG. 8 represents a symmetric configuration of a cell stack. In some embodiments two or more cells 100 adjacent to each other can form a symmetric configuration stack 190a and 190b, where electrodes 101 and electrode 102 of adjacent cells 100 are facing towards each other. In some embodiments, the electrode 102 or individual elements of the electrode 102 (i.e., 154, 155, 156 as shown in FIG. 2A) can be configured in such a way as to allow fluidic connection between the gas in electrode 102 of adjacent cells 100 and in some cases electrical connection between elements of electrode 102 (see FIG. 2A) of adjacent cells 100.

In some embodiments, the electrodes 102 or individual elements of electrodes 102 (i.e., 154, 155, 156 as shown in FIG. 2A) of adjacent cells 100 can be substituted by a single shared element of the adjacent cells 100 as can be seen in configuration 190b. As an example, several elements 156 (FIG. 2A) of a three layers configuration (i.e., elements 154, 155, 156) can be replaced by a single, shared element 156; several elements 155 of a two layers configuration (i.e., elements 154, 155) can be replaced by a single, shared element 155; several elements 154 of a onc-layer configuration (i.e., element 154) can be replaced by a single, shared element 154. In some embodiments, the electrode 101 or individual elements of the electrode 101 (i.e., 151, 153, 152 as shown in FIG. 1C) can be configured in such a way as to allow fluidic connection between the gas in electrode 101 of adjacent cells 100 and in some cases electrical connection between elements 151 of adjacent cells 100. In some embodiments, the electrodes 101 or individual elements of electrodes 101 (i.e., 151, 153, 152 as shown in FIG. 1C) of adjacent cells 100 can be substituted by a single shared element of the adjacent cells 100 as can be seen in configuration 190b. As an example, several elements 152 (FIG. 1C) of a three layers configuration (i.e., elements 151, 153, 152) and two-layer configuration (i.e., elements 151, 152) can be replaced by a single, shared element 152; several elements 151 of a one-layer configuration (i.e., element 151) can be replaced by a single, shared element 151.

In some embodiments, a separation plate 181 can be placed between adjacent cells 100 of the linear and symmetric configuration stacks. In particular, electrode 101 of the cell 100 and electrode 102 of the adjacent cell 100 in a linear configuration stack. In some embodiments, elements 152, 154, 155, 156 (FIG. 1C, FIG. 2A) of the adjacent cells 100 can function as separation plate of both linear configuration stack and of symmetric configuration stack. In some embodiments, separation plates of linear configuration stack can largely restrict the flow between the gas in electrode 102 and the gas in electrode 101. In some embodiments, separation plates provide fluidic connection between gases of adjacent electrodes 102 and/or between gases of the adjacent electrodes 101. In some embodiments, separation plates can provide the means to transport the gas 106 and/or gas 107 along the separation plate plane (along plane of the cell 100). Examples include groves, indentations, multilayer and composite structures including porous materials etc.

In some embodiments, separation plate can be made from conductive material and hence enable electrical connection between various elements of the adjacent cells 100 based on configuration. In some embodiments, separation plates can be made from non-conductive materials. The means of the electrical connection between elements of adjacent cells 100 across separation plates made of non-conductive materials may include electrical connection at and over the edge of the separation plate; electrical connection through separation plate via conductive elements imbedded within separation plate; and electrical connection through conductive elements inserted through separation plate and sealed in such a way as to prevent fluidic connection between any gas and/or liquid across separation plates.

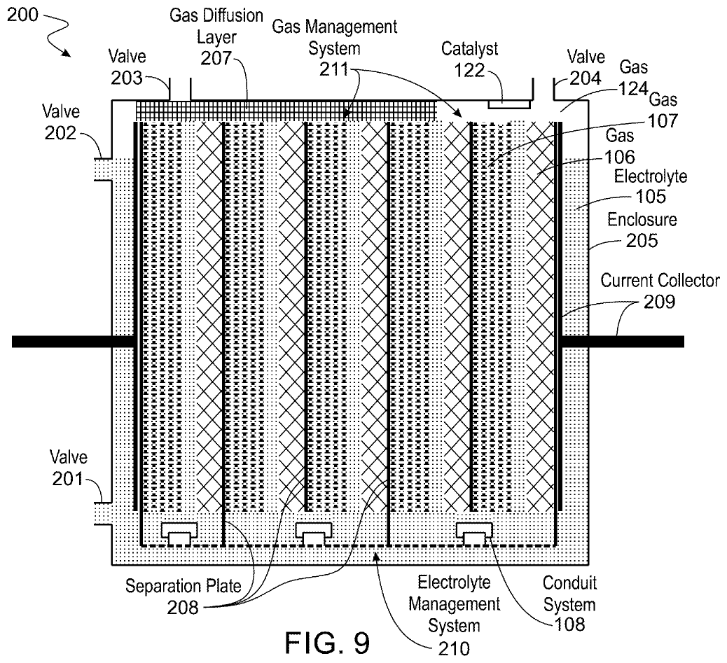

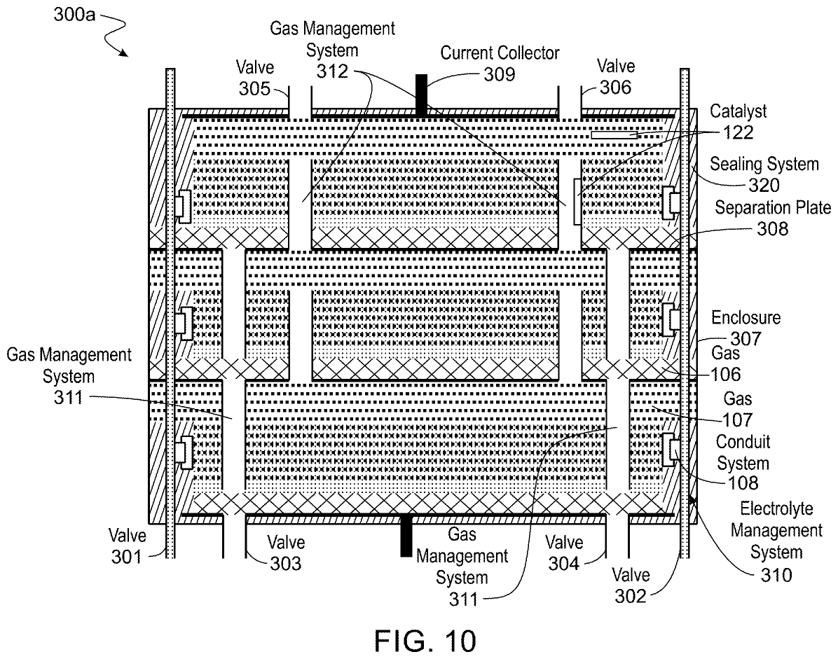

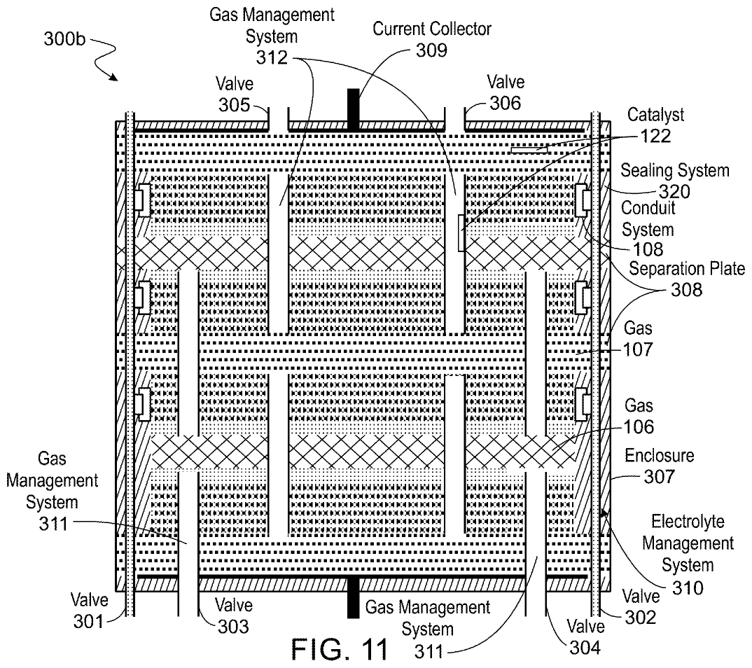

In some embodiments, some or all of the separation plates can prevent fluidic connection across separation plate between electrolyte of individual cells 100. A number of adjacent cells 100 where separation plate does not prevent fluidic connection of the electrolyte can form a common electrolyte set. A common electrolyte set can be fluidly connected to the electrolyte management system through a common conduit system 108 (as shown in FIG. 9, FIG. 10, and FIG. 11). It is advantageous that cells 100 within common electrolyte set are electrically connected in parallel while cells 100 between individual electrolyte sets are electrically connected in series.

FIG. 9 is a drawing of a common pressure linear configuration stack 200. Description can be equally applied to a common pressure symmetric configuration stack. Electrolyte 105, gas 106, gas 107 of individual cells 100 and gas 124 are disposed within a common enclosure 205 and are fluidically connected. Electrolyte 105, gas 106, and gas 107 can occupy various parts of the enclosure 205, however, electrolyte 105 is prevented from flowing into the gas space 106 of the electrode 102 and gas space 107 of the electrode 101, valves 203 and 204. These may be accomplished through surface modification of some or all of the elements of electrodes 101, 102, and enclosure 205; inclusion of additives and/or interpenetrating networks of hydrophobic materials and polymers; inclusion of chemical compounds in the structure of electrodes 101, 102, enclosure 205 that prevent transfer of aqueous electrolytes; by elevating electrodes 101, 102, valves 203, 204 above the level of the electrolyte 105 in the enclosure 205.

In some implementations, separation plates 208 may support the mechanical structure of the cell 100, evenly distributes gases 106, 107 and electrolyte 105 along cell 100, conduct heat, and conduct electricity. Suitable examples of conductive materials include graphite that is prepared by mixing graphitized resin with carbon powder or graphite powder, metal prepared by direct processing of stainless steel, titanium alloy, aluminum alloy, or a composite material. Examples of composite materials include thermoplastic or thermosetting resin materials, which are mixed with graphite powder and reinforcing fibers to form a prefabricated material, which is cured and graphitized before molding. Examples of non-conductive materials include plastics, rubbers, ceramics, glasses, etc.

Gas diffusion layers 207 may be used to provide fluid connection between gas space 106 and 107 of electrodes 101, 102 and valves 203, and 204 while substantially preventing flooding with electrolyte 105. The gas diffusion layer 207 can be selected from materials and structures permeable to gas (e.g., hydrogen and/or oxygen) but impermeable to electrolyte 105. This configuration allows minimum differential pressure between electrolyte 105 and gas 106 across separator 104 during device operation.

Valves 201 and 202 are fluidically connected with electrolyte 105 through conduit system 108 and electrolyte management system 210. Valve 201 and valve 202 may be used to withdraw or supply electrolyte and or water mixture to the cells 100. In some embodiments, a single bidirectional valve can replace valve 201 and valve 202.

In some embodiments, a single bidirectional valve can be fluidly connected to gas space 124 and gas management system. A single bidirectional valve can replace valves 203, 204.

Common pressure linear stack configuration may include catalyst 122 fluidically connected to gas space 124 to catalyze reaction between hydrogen and oxygen to form water. The catalyst 122 in some cases may have electrical connection with an enclosure 205.

Current collectors 209 in contact with electrode 101 and electrode 102 enable withdrawal of electrical current from cells 100 while allowing to maintain differential pressure between gasses and liquids across enclosure 205. In some embodiments, both current collectors 209 are not electrically connected with the enclosure 205. In some embodiments, one current collector 209 is electrically connected with the enclosure 205.

FIG. 10 is a drawing of a differential pressure linear configuration stack 300a and FIG. 11 is a drawing of a differential pressure symmetric configuration stack 300b. Electrolyte 105 of individual cells 100 is fluidically connected to the valve 301 and 302 through conduit systems 108 and electrolyte management system 310. In some embodiments, a single bidirectional valve can replace valves 301 and 302. The gas of the electrode 101 of individual cells is fluidically connected to valves 303 and 304 through gas management system 311. In some embodiments, a single bidirectional valve can be fluidically connected to the gas from the second electrode of individual cells 100 through gas management system 311. The gas from first electrode of individual cells is fluidically connected to valves 305 and 306 through gas management system 312. In some embodiments, a single bidirectional valve can be fluidically connected to the gas of first electrode of individual cells 100 through gas management system 312.

In some embodiments, electrolyte of individual cells 100 can be at a higher pressure compared to the gas 106 and gas 107 (e.g., less than 0.1 bar, 0.2 bar, 0.5 bar, 1 bar, etc.). In some embodiments gas 106 can be at a different pressure compared to the gas 107 as long as pressure of both gases does not exceed that of electrolyte. Electrolyte of individual cells 100 is largely prevented from fluidic connection by the use of separation plates 308 and sealing system 320. In some embodiments, sealing system is used to prevent electrolyte fluidic connection across the joint between separation plates 308. In some embodiments, sealing system is used to prevent electrolyte fluidic connection across the joint between separation plates 308 and enclosure 307.

Electrolyte 105 and sealing system 320 prevent fluidic connection between gas 106 and gas 107. Separation plate 308 prevent fluidic connection between gas 106 and gas 107 of the linear configuration stack. Electrolyte management system 310 is fluidically isolated from gas 106 and gas 107 using the sealing system 320. Gas management system 311 is fluidically isolated from gas 107 and the electrolyte using the sealing system 320.

Sealing system 320 can include structural adhesives, pressure sensitive adhesives, thermosetting structural adhesives, sealants based on acrylic, butyl, water-based latex, silicone, polysulfide, polyisobutylene, polyurethane as well as fasteners, mechanical assemblies as well as utilize seaming, rolling, cutting, and welding techniques, among others.

Differential pressure configuration may include catalyst 122 fluidically connected to the gas management system 311 and/or 312 to catalyze the reaction between hydrogen and oxygen to form water.

Current collectors 309 in contact with electrodes 101 and 102 enable withdrawal of electrical current from cells while allowing to maintain differential pressure between gasses and liquids across enclosure 307. In some embodiments, both current collectors 309 are not electrically connected with the enclosure 307. In some embodiments, one current collector 309 is electrically connected with the enclosure 307.

Multiple cell assembly configurations (i.e., FIG. 9, FIG. 10, and FIG. 11) can have electrolyte/water mixtures of electrolyte management system fluidically connected to electrolyte 105 of individual cells 100 and subsequently provide the means to conduct ions between individual cells 100. This may not be desirable for an efficient operation. The ways to increase overall electrical resistance of the electrolyte/water mixtures between individual cells 100 may be introduced as part of the conduit system 108, electrolyte management system 210/310 or separation plates 208/308. Various configurations may include reducing cross sectional surface area of the fluid flow path, increasing the length of the fluid flow path between individual cells and in some cases terminating fluidic connection between electrolyte 105 of individual cell 100 and electrolyte management system using a system of valves and/or check valves.

The amount of water in electrolyte 105 can change during operation due to water oxidation reaction, water reduction reaction, water evaporation, among others. The electrolyte management system allows to maintain required water content in electrolyte 105. Several examples of electrolyte management systems are given below for either common pressure cell stack configuration or differential pressure cell stack configuration. However, it is to be understood that the description of the electrolyte management system 500 and 600 may be equally applied to either cell stack configurations. In some embodiments, electrolyte management system may include multiple cell stacks 200/300a/300b.

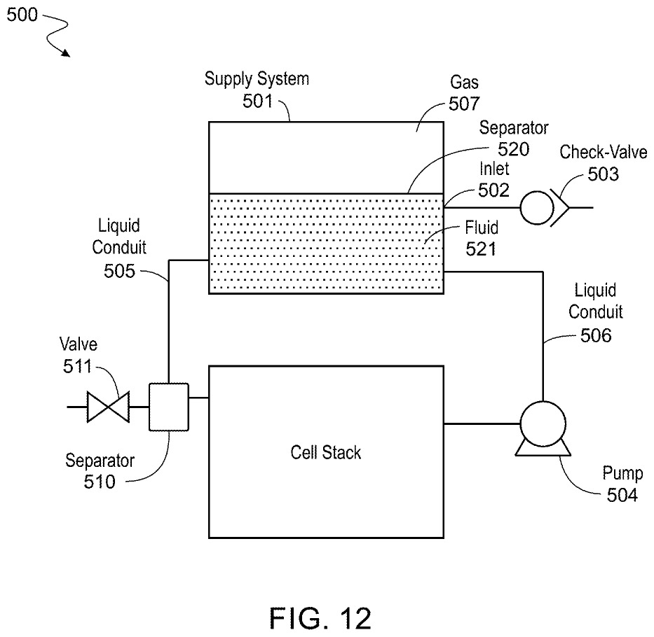

FIG. 12 is a drawing of a electrolyte management system 500 that has two liquid conduits. Supply system 501 includes a tank comprising fluidically connected gas 507 and fluid 521. The tank can be made of any material with sufficient chemical resistance to the electrolyte. Fluid 521 chemical composition is based on the electrolyte in the cell, where concentration of dissolved chemicals varies between zero weight percent (i.e., distilled water) up to the maximum solubility limit at a given working temperature to prevent crystallization. Fluid 521 may comprise some of the gas 106 and/or some of the gas 107 (as described in FIG. 9, FIG. 10, and FIG. 11) in a dissolved form or in a gas bubble form. In some embodiments, supply system 501 includes separator 520 disposed between gas 507 (includes gas 106, gas 107, or other gas such as air or nitrogen) and fluid 521. Separator 520 can accommodate volume change of gas 507 and fluid 521 and thus maintain substantially equal pressure between gas 507 and fluid 521 (e.g., within 0.01 bar, within 0.1 bar) without direct contact between gas 507 and fluid 521. Examples include the use of flexible materials such as metals and polymers connected to the fluid tank or the use of materials that can act as a piston within the fluid tank. In some embodiments, the fluid tank of the supply system 501 can be pressurized up to 1 bar, 5 bar, 10 bar, 20 bar, 30 bar, etc.

The supply system 501 can be connected to the electrolyte management system 210 though valves 201, 202 (as described in FIG. 9) and to electrolyte management system 310 through valves 301, 302 (as described in FIG. 10 and FIG. 11) of the cell stack using liquid conduits 505 and 506.

A pump 504 connected to the liquid conduits 505 and/or 506 can be used to supply and/or circulate fluid 521 between supply system 501 and electrolyte management systems (i.e., 210 and 310) of the cell stack.

In some embodiments, fluid 521 can be supplied/circulated between supply system 501 and cell stack due to density variation between electrolyte 105 in connection with electrolyte management systems (i.e., 210 and 310) and fluid 521. In some implementations, density variation is caused by the difference of temperature or salt concentration between electrolyte 105 and fluid 521. In some embodiments, fluid 521 can be supplied/circulated between supply system 501 and cell stack due to buoyancy of the gas 107 and/or the gas 106, as well as pressure variation of the gas 106 and/or the gas 107 in the cell 100 during operation using a combination of a set of valves and/or check valves. In another implementation, fluid 521 can be supplied/circulated between supply system 501 and cell stack due to change in volume of the electrolyte 105, caused by increase or decrease of the water content in electrolyte 105 during operation. electrolyte management system can include separator 510 fluidically connected to liquid conduit 505 and/or 506 to separate gas 107 and/or gas 106 that may be present in fluid 521. The gas 107 and/or gas 106 separated from fluid 521 can be released using valve 511.

The supply system 501 may contain means to inject fluid (e.g., pure water) using inlet 502 and an optional check-valve 503. The fluid 521 in supply system 501 may be kept at a differential pressure compared to the electrolyte management system (i.e., 210 and 310) and electrolyte 105 of the cells 100. Implementations include maintaining differential elevation between supply system 501 and cell stack configuration 500 or changing pressure of the gas 507.

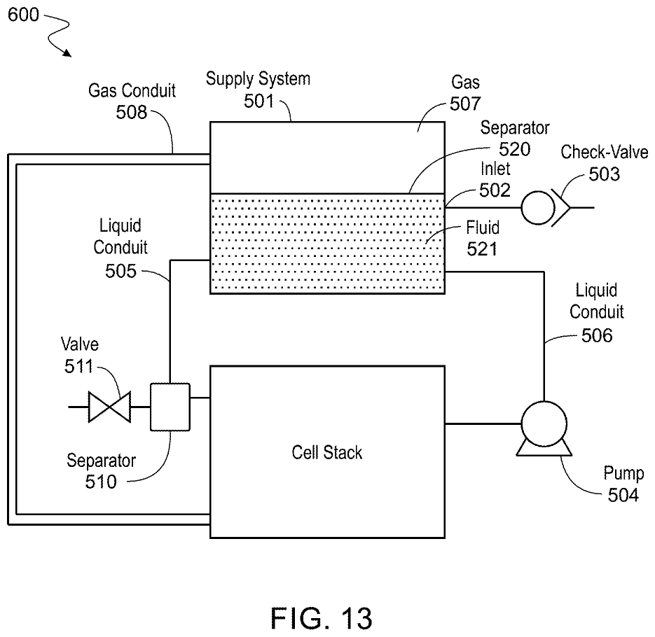

FIG. 13 is a drawing of a electrolyte management system 600 that includes a gas conduit 508 along with two liquid conduits. Gas conduit 508 can provide fluid connection of gas 507 with gas management system (i.e., 311, 312 or 211 as described in FIG. 9, FIG. 10, and FIG. 11) through valves 303, 304, 305, 306, 203, or 204. Electrolyte management system 600 includes a liquid pump 504, liquid conduits 505 and 506, an inlet 502 by which water can be injected to the supply system 501, and an optional check-valve 503 connected to the inlet 502. In this configuration it is possible to maintain pressure difference between electrolyte 105 and gas 106 and/or gas 107 of the cell 100 during operation (i.e., with changes in pressure of gas 106 and/or gas 107). The fluid 521 may be kept at a differential pressure compared to the electrolyte 105 of the cell stack. Implementations include maintaining differential elevation between supply system 501 and cell stack. Electrolyte management system can include separator 510 fluidically connected to liquid conduit 505 and/or 506 to separate gas 107 and/or gas 106 that may be present in fluid 521. The gas 107 and/or gas 106 separated from fluid 521 can be released using valve 511. In some embodiments, supply system 501 includes separator 520 disposed between gas 507 and fluid 521. Separator 520 can accommodate volume change of gas 507 and fluid 521 and thus maintain substantially equal pressure between gas 507 and fluid 521 (e.g., within 0.01 bar, within 0.1 bar) without direct contact between gas 507 and fluid 521.

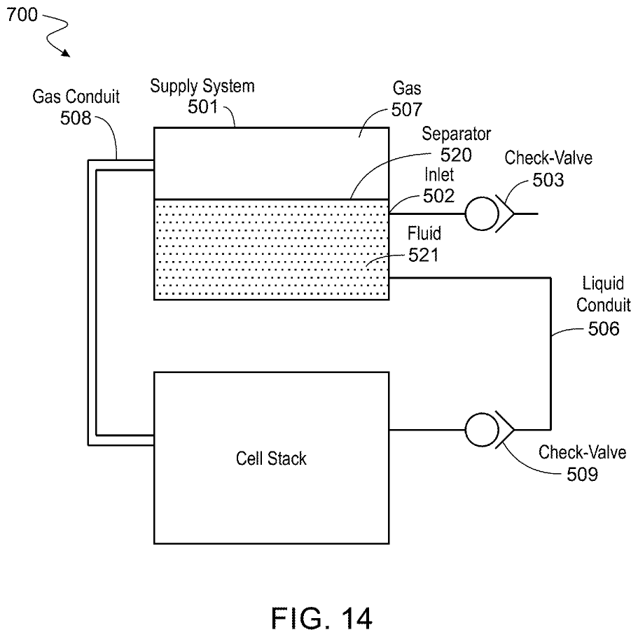

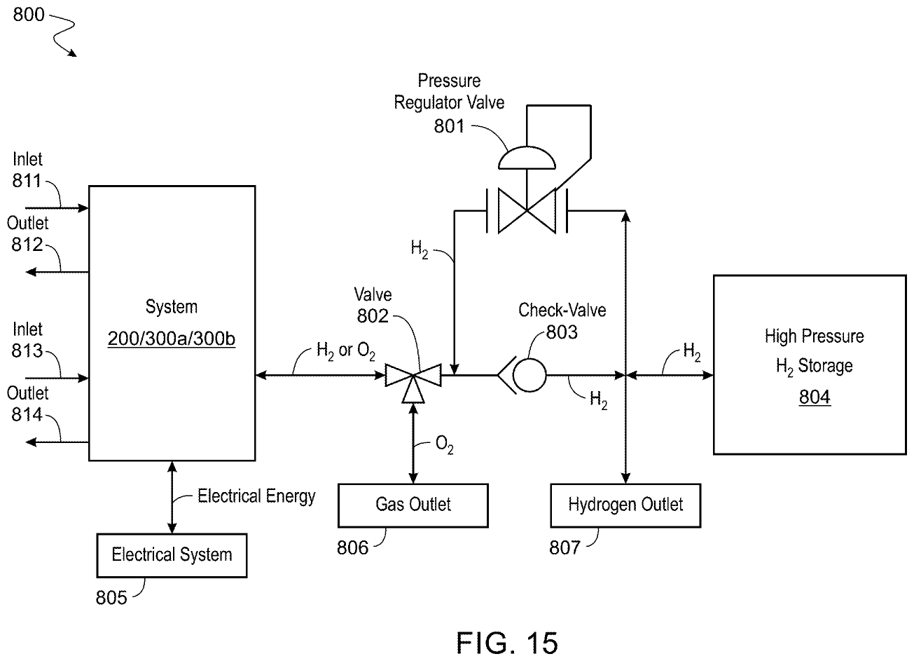

FIG. 14 is a drawing of a electrolyte management system 700 with a gas and a liquid conduit. Supply system 501 is connected to the electrolyte management system (i.e., 210 and 310) through valves 301 and or 201 (as described in FIG. 9, FIG. 10, FIG. 11) using a liquid conduit 506 with an optional check-valve 509. The supply system 501 may contain gas 507 in contact with the fluid 521 as well as the means to supply fluid (e.g., pure water) using inlet 502 and an optional check-valve 503. The fluid 521 in the supply system 501 may be kept at a differential pressure compared to the electrolyte 105 of the cell stack. Implementations include maintaining differential elevation between supply system 501 and cell stack or changing the pressure of the gas 507.

In a particular implementation, fluid 521 is transferred from supply system 501 to the cell stack due to change in volume of the electrolyte 105, that occur when the amount of water in electrolyte 105 is reduced during operation.

In some implementations, the fluid 521 is a pure water or a water with low salt content (e.g., salt content <10 wt %, <1 wt %, <0.1 wt %, 0.01 wt %). The fluid 521 can be supplied through electrolyte management system (i.e., 210 and 310 as described in FIG. 9, FIG. 10, and FIG. 11) of cell stack to multiple individual electrochemical devices 100. The low salt content of the fluid 521 results in lower electrical resistance across the fluid between individual cells 100. This may consequently simplify the overall design of the cell stack. Gas conduit 508 can provide fluid connection of gas 507 with gas management system. In some embodiments, supply system 501 includes separator 520 disposed between gas 507 and fluid 521. Separator 520 can accommodate volume change of gas 507 and fluid 521 and thus maintain substantially equal pressure between gas 507 and fluid 521 (e.g., within 0.01 bar, within 0.1 bar) without direct contact between gas 507 and fluid 521. The supply system 501 is connected to the electrolyte management system of the cell using the liquid conduit 506.

Implementation of a gas distribution system given below can be equally applied to electrolyte management system 500, 600, and 700 including one or multiple cell stacks 200/300a/300b.

FIG. 15 shows a gas distribution system 800. Valve 802 is fluidically connected to the gas management system (i.e., 211, 311 as described in FIG. 9, FIG. 10, and FIG. 11) of the cell stack. Electrical energy can be supplied from an electrical system 805 to the cell stack during electrical energy storage cycle, cell balancing type 1 cycle, withdrawn during electrical energy release cycle, and remain neutral during idling or cell balancing type 2 cycle. Comparatively smaller amounts of electrical energy can be supplied during cell balancing type 3 cycle and cell unbalancing cycle or withdrawn during cell balancing type 3 cycle. In some embodiments, electrical system 805 can include intermittent renewable power sources, energy storage systems, electrical grid, and/or individual cell stacks of various configurations.

During electrical energy storage cycle, the redox reactive material of the electrode 101 is oxidized, while water is reduced to hydrogen in the electrode 102, increasing hydrogen gas pressure in the gas 106 and management system (i.e., 211, 311 as shown in FIG. 9, FIG. 10, and FIG. 11) of the cell stack. Valve 802 enables hydrogen flow from cell stack, through check-valve 803 and into gas pipeline connected to the hydrogen storage 804. An example of hydrogen storage 804 includes compressed gas storage cylinders, metal hydride storage system, reversible organic and inorganic chemical system, or any combination of the above. The means to compress hydrogen gas may be installed between valve 802 and check-valve 803 to increase hydrogen pressure supplied to the hydrogen storage 804, compared to the hydrogen pressure generated in the cell stack.

Over time a portion of the hydrogen can diffuse through electrolyte 105 (in the electrochemical cell 100) and/or separator 104 of the electrochemical cell 100 and recombine with the redox reactive material of electrode 101, leading to gradual self-discharge. The rate of self-discharge strongly depends on the operating temperature, diffusion length (i.e., distance between space occupied by gas 106 and element 151 across electrode 101) and hydrogen gas pressure in the gas 106 and electrode 102. A pressure regulator valve 801 can be installed parallel to the check-valve 803 to enable flow of hydrogen gas between hydrogen storage 804, through valve 802 and into cell stack at required pressure (e.g., lower pressure than that in the hydrogen storage) and enables to reduce rate of self-discharge during cycles other than electrical energy storage cycle. It may also be advantageous that the overall system is designed in a way to minimize gas space available for the gas 106 in the cell stack prior to check-valve 803 and pressure regulator valve 801 (i.e., space for gas 106, elements 155, 166, 124, 211, 311), so that most of the hydrogen produced during the electrical energy storage cycle is transferred to the hydrogen storage 804.

Hydrogen outlet 807 enables withdrawal of some or all of the hydrogen gas from hydrogen storage 804 for various applications. Not limiting, examples of applications that include the use of hydrogen are in hydrogen refueling stations, hydrogen fuel cells for electric vehicles, as a chemical feedstock, and as a means to provide long term storage of electrical energy.

During electrical energy release cycle, redox reactive material of electrode 101 is reduced while the hydrogen is oxidized to water in the electrode 102. This process reduces partial hydrogen gas pressure in the gas 106 and enables gas flow from the hydrogen storage 804 through pressure regulator valve 801 and valve 802 to the cell stack.

During the cell balancing cycle type 3, valve 802 is positioned to enable fluid connection between cell stack and gas outlet 806. Redox reactive material of electrode 101 is reduced while hydrogen gas that remains in cell stack and gas pipelines connecting cell stack and valve 802 is oxidized. Partial hydrogen gas pressure is reduced and a portion of gas other than hydrogen may be allowed to flow from gas outlet 806 into the gas 106 of the cell stack to maintain required gas pressure of the gas 106. Upon further reduction of redox reactive material of electrode 101, the water is oxidized to oxygen gas increasing partial oxygen gas pressure in the gas 106 of cell stack. Valve 802 enables gas 106 flow from cell stack, through gas outlet 806. The cell balancing cycle type 3 continues until redox reactive material of electrode 101 is fully reduced or cell stack is required to operate in another cycle. In some embodiments, small amount of oxygen and/or other gases present in gas 106 can be vented using gas outlet 806. During electrical energy release cycle valve 802 re-enables fluid connection between the gas 106 of the cell stack, check-valve 803, and pressure regulator valve 801. Small amounts of oxygen that remains in cell stack and gas pipelines connecting cell stack and valve 802 is reduced in the electrode 102 during energy storage cycle, and/or allowed to recombine on catalyst 122 with hydrogen gas produced during energy release cycle or supplied from hydrogen storage 804 during electrical energy release cycle. Inlets 811 and 813 and outlets 812 and 814 serve as a means of gas movement between the cell stack and gas management system.

During cell balancing cycles type 1 and/or type 2 the oxygen gas produced in the electrode 101 increases the pressure of the gas 107 and can be withdrawn from cell stack using gas management system (i.e., 312, 211). Gas 107 predominantly contains oxygen and can be vented into the atmosphere or stored.

During cell unbalancing cycle valve 802 is positioned to enable fluid connection between cell stack and gas outlet 806. Oxygen gas, air or gas with oxygen content exceeding 20% can be supplied to the gas management system (i.e., 311, 211) through valve 303 and/or 203 (as described in FIG. 9, FIG. 10, and FIG. 11). Redox reactive material of electrode 101 is oxidized while oxygen gas in the gas 106 is reduced to water. A portion of the gas 106 can be withdrawn from gas management system (i.e., 311, 211 as described in FIG. 9, FIG. 10, and FIG. 11) using valve 304 and/or 204 to maintain partial pressure of oxygen in gas 106 (e.g., above 1%, above 5%, above 10%, above 15% etc.) and/or water content in the electrolyte 105.

In some embodiments, water content of the electrolyte 105 in various configuration of cell stack can be reduced by supplying gas with low water vapor to the gas management system (i.e., 311, 211) through valve 303 and/or 203 and withdrawing gas 106 using valve 304 and/or 204 in particular during cell unbalancing cycle and cell idling cycle.

In some embodiments, water content of the electrolyte 105 in various configuration of cell stack can be reduced by supplying gas with low water vapor to the gas management system 312 through valve 305 and withdrawing gas 107 using valve 306 in particular during cell unbalancing cycle, electrical energy storage cycle, electrical energy release cycle and cell idling cycle.

A safety vent can be installed to release the gas when the internal pressure in the gas management system 800 exceeds a predetermined level. In addition to preventing the absorption of external air into the system, this vent also prevents the rupture of the enclosure that would result from the increase in internal pressure caused by the excessive generation of gas.

An embodiment described herein provides a hybrid electrochemical device which comprises a first electrode that includes a redox reactive material or an alloy based on transition metal; a second electrode that includes a multi-functional catalyst to catalyze hydrogen evolution reaction, hydrogen oxidation reaction, and water oxidation reaction at the second electrode; a separator disposed between the first and second electrode; an electrolyte disposed between the first electrode and the second electrode; a conduit system that includes the means to replenish water loss in the electrolyte during electrochemical device operation, and an enclosure within which the first electrode, the second electrode, the separator, the electrolyte, and conduit system are disposed; wherein the first electrode and separator includes the means to minimize spatial variation of electrolyte concentration and temperature within the cell. The hybrid electrochemical storage device has at least a valve that is fluidically connected to an electrolyte/management system and another valve that is fluidically connected to the gas management system.

An aspect described herein provides a method of configuring a hybrid electrochemical storage device in a stacked configuration. The hybrid electrochemical storage device includes several individual electrochemical storage devices that are stacked on top of each other. The individual electrochemical storage device comprises a first electrode that includes a redox reactive material or an alloy based on transition metal; a second electrode that includes a multi-functional catalyst to catalyze hydrogen evolution reaction, hydrogen oxidation reaction, and water oxidation reaction at the second electrode; a separator disposed between the first and second electrode; an electrolyte disposed between the first electrode and the second electrode; a separation plate disposed between individual electrochemical devices, an enclosure within which each of the individual electrochemical storage device arranged in a stacked configuration are disposed. The stacked configuration of electrochemical storage device includes valves that are fluidically connected to the electrolyte management system and gas management system.

Other implementations and modifications are also within the scope of the following claims. Those skilled in the art may make various modifications and changes in the configuration, materials, and equivalents without departing from the scope of the disclosure.

1. A hybrid electrochemical energy storage device, comprising:
a first electrode comprising of a redox reactive material, or an alloy based on a transition metal;
a second electrode comprising a multi-functional catalyst to catalyze hydrogen evolution reaction, hydrogen oxidation reaction, and water oxidation reaction;
an electrolyte disposed between the first electrode and the second electrode, wherein the first electrode includes means to minimize spatial variation of the electrolyte concentration and temperature within the hybrid electrochemical energy storage device;
a separator disposed between the first electrode and the second electrode, wherein the separator includes means to minimize spatial variation of electrolyte concentration and temperature within the hybrid electrochemical energy storage device;
a conduit system fluidically connected to the electrolyte that includes means to replenish water loss in the electrolyte during operation; and
an enclosure within which the first electrode, the second electrode, the electrolyte, the separator, and the conduit system are disposed.

2. The hybrid electrochemical energy storage device of claim 1, wherein the first electrode includes a composite structure with multiple layers of conductive substrates and non-conductive substrates that enable electrical connection and mechanical support of the redox reactive material.

3. The hybrid electrochemical energy storage device of claim 2, wherein the composite structure of the first electrode is used to enable fluid connection between the electrolyte and the redox reactive material.

4. The hybrid electrochemical energy storage device of claim 2, wherein the first electrode is coated with redox reactive material selected from Ni(OH)₂, NiOOH, or Ni(OH)₂ doped with one or more elements selected from a transition metal group.

5. The hybrid electrochemical energy storage device of claim 2, wherein the first electrode includes surface modifications to minimize spatial variation of electrolyte concentration and temperature along the first electrode and the hybrid electrochemical energy storage device.

6. The hybrid electrochemical energy storage device of claim 2, wherein the composite structure of the first electrode can facilitate gas transfer across first electrode.

7. The hybrid electrochemical energy storage device of claim 2, wherein the composite structure of the first electrode can support a metal catalyst for the recombination of hydrogen and oxygen to form water, water oxidation to oxygen, or a water reduction catalyst.

8. The hybrid electrochemical energy storage device of claim 1, wherein the second electrode comprises a composite structure with multiple layers of electrically connected conductive substrates and non-conductive substrates adjacent to the electrically connected conductive substrates.

9. The hybrid electrochemical energy storage device of claim 8, wherein the composite structure is used for electrical connection and mechanical support of the multi-functional catalyst.

10. The hybrid electrochemical energy storage device of claim 9, wherein the composite structure comprises a catalyst to catalyze oxygen reduction reaction as part of the multi-functional catalyst.

11. The hybrid electrochemical energy storage device of claim 8, wherein the composite structure of the second electrode can provide a fluid connection between the electrolyte and the multi-functional catalyst and facilitate gas transfer across the second electrode.

12. The hybrid electrochemical energy storage device of claim 8, wherein the composite structure of the second electrode includes a catalyst to facilitate recombination of oxygen and hydrogen gas present in the second electrode.

13. The hybrid electrochemical energy storage device of claim 1, wherein the multi-functional catalyst includes metal alloys, precious metals, and/or transition metals and the multi-functional catalyst is microstructured or nanostructured.

14. The hybrid electrochemical energy storage device of claim 1, wherein the separator comprises a composite structure with multiple layers that include conductive and non-conductive substrates.

15. The hybrid electrochemical energy storage device of claim 14, wherein the separator electrically isolates the first electrode and the second electrode, prevents gas transfer between the first electrode and the second electrode, includes means to minimize spatial variation of electrolyte concentration and temperature.

16. The hybrid electrochemical energy storage device of claim 1, wherein the electrolyte is an aqueous alkaline solution.

17. The hybrid electrochemical energy storage device of claim 1, wherein the enclosure has at least one valve that is fluidically coupled to the electrolyte, and another valve that is fluidically connected to a gas space of the second electrode to convey or discharge the gas from the hybrid electrochemical energy storage device.

18. A hybrid electrochemical energy storage device comprising:
a first electrode comprising of redox reactive material, or an alloy based on transition metal;
a second electrode comprising a multi-functional catalyst to catalyze hydrogen evolution reaction, hydrogen oxidation reaction, and water oxidation reaction;
a separator disposed between the first electrode and second electrode;
an electrolyte disposed between the first electrode and second electrode;
a conduit system comprising means to replenish water loss during operation and to convey or discharge gas from the electrochemical energy storage device;
a stacked configuration that comprises a plurality of individual hybrid electrochemical energy storage devices; and
an enclosure within which the stacked configuration comprising plurality of the individual hybrid electrochemical energy storage device is disposed.

19. The hybrid electrochemical energy storage device of claim 18, wherein the individual hybrid energy storage device in a stacked configuration can be separated from each other by a separation plate or the individual hybrid energy storage devices are fluidically connected with each other.

20. The hybrid electrochemical energy storage device of claim 19, wherein the separation plate comprises of materials such as graphite, metal, metal alloy, composite material, or elements of the first electrode or the second electrode.

21. The hybrid electrochemical energy storage device of claim 18, is fluidically connected to an electrolyte management system and a hydrogen gas storage system.

22. The hybrid electrochemical energy storage device of claim 18, wherein the first electrode includes a composite structure with both conductive and non-conductive substrates, which is coated with redox reactive material selected from Ni(OH)₂, NiOOH, or Ni(OH)₂ doped with one or more elements selected from a group comprising transition metals such as cobalt, zinc, and or manganese.

23. The hybrid electrochemical energy storage device of claim 18, wherein the second electrode includes a composite structure with both conductive and non-conductive substrates and is coated with the multi-functional catalyst.

24. A method of operation for electrical energy storage and hydrogen gas production using device of claim 1 in a fully reversible mode comprising:
storing electrical energy by:
oxidizing a redox reactive material on the first electrode;
reducing H₂O to hydrogen on the second electrode; and
releasing electrical energy by:
reducing the redox reactive material on the first electrode;
oxidizing hydrogen to H₂O on the second electrode.

25. A method of claim 24, wherein the device of claim 1 is configured for partial storage of electrical energy and hydrogen production from electricity.

26. A method of claim 24, wherein the device of claim 1 is configured for storage of electrical energy and electricity generation from hydrogen.
